(19) United States
(12) Patent Application Publication
(10) Pub. No.: US 2020/0193415 A1
(43) Pub. Date: Jun. 18, 2020

(54) SYSTEMS AND METHODS FOR USING INTEGRATED PAY-ON-DEMAND VIRTUAL CARDS

(71) Applicant: JPMorgan Chase Bank, N.A., New York, NY (US)

(72) Inventors: Christopher Claus, Chicago, IL (US); Sebastian Guerra, Scarsdale, NY (US); Brian Emerson Holcomb, Parrish, FL (US); Tu P. Le, Chicago, IL (US)

(21) Appl. No.: 16/220,853

(22) Filed: Dec. 14, 2018

(51) Int. Cl. G06Q 20/34; G06Q 20/38

(52) U.S. Cl. CPC G06Q 20/351; G06Q 20/3827; G06Q 20/389

(57) ABSTRACT

Systems and methods for using integrated pay-on-demand virtual cards are disclosed. According to one embodiment, a method for using pay-on-demand virtual payment cards may include: (1) receiving, from a buyer electronic device, a selection of one or more goods or services offered by a supplier in the online marketplace and an indication that the buyer will use a pay-on-demand virtual payment card to pay for the goods or services; (2) receiving, from the buyer electronic device or a backend for a financial institution associated with the pay-on-demand virtual payment card, information for the pay-on-demand virtual payment card; (3) associating the pay-on-demand virtual payment card with the goods or services in a transaction; (4) providing the transaction to the backend for the financial institution; and (5) receiving a reconciliation file for the transaction from the backend for the financial institution.

### BACKGROUND OF THE INVENTION

### 1. Field of the Invention

The present disclosure generally relates to systems and methods for using integrated pay-on-demand virtual cards.

### 2. Description of The Related Art

Business-to-business (B2B) transactions conducted using standard credit cards, the ACH network or paper checks can be slow to reconcile and difficult to track. In addition, there is always a possibility that a credit card or bank account number could be intercepted and fraudulently used. Vendors are generally waiting for payment to arrive after the buying organization has received the goods and approved an invoice, making the money flow inefficient.

### SUMMARY OF THE INVENTION

Systems and methods for using integrated pay-on-demand virtual cards are disclosed. According to one embodiment, in an information processing apparatus for an online marketplace comprising at least one computer processor, a method for using pay-on-demand virtual payment cards may include: (1) receiving, from a buyer electronic device, a selection of one or more goods or services offered by a supplier in the online marketplace and an indication that the buyer will use a pay-on-demand virtual payment card to pay for the goods or services; (2) receiving, from the buyer electronic device or a backend for a financial institution associated with the pay-on-demand virtual payment card, information for the pay-on-demand virtual payment card; (3) associating the pay-on-demand virtual payment card with the goods or services in a transaction; (4) providing the transaction to the backend for the financial institution; and (5) receiving a reconciliation file for the transaction from the backend for the financial institution.

In one embodiment, the pay-on-demand virtual payment card may include a single use account number, a limited use account number, etc.

In one embodiment, the method may include requesting, from the financial institution, the pay-on-demand virtual payment card. The request may be made using an application programmable interface.

In one embodiment, the method may further include committing the transaction to a distributed ledger.

In one embodiment, the step of receiving, from the buyer electronic device or a backend for a financial institution associated with the pay-on-demand virtual payment card, information for the pay-on-demand virtual payment card may include selecting the pay-on-demand virtual payment card from one of a plurality of pools of pay-on-demand virtual payment cards based on a payment process.

In one embodiment, the plurality of pools of pay-on-demand virtual payment cards may be grouped by bank identification number.

In one embodiment, the payment process may include an ACH channel, an electronic payment network, etc.

According to another embodiment, a system for using pay-on-demand virtual payment cards may include an online marketplace comprising a plurality of goods or services, each good or service associated with a supplier; a financial institution backend in communication with the online marketplace; and a buyer electronic device in communication with the online marketplace. A backend for the online marketplace may: receive, from the buyer electronic device, a selection of one of the plurality of goods or services and an indication that the buyer will use a pay-on-demand virtual payment card to pay for the goods or services; receive, from the buyer electronic device or a backend for the financial institution associated with the pay-on-demand virtual payment card, information for the pay-on-demand virtual payment card; associate the pay-on-demand virtual payment card with the goods or services in a transaction; provide the transaction to the backend for the financial institution; and receive a reconciliation file for the transaction from the backend for the financial institution.

In one embodiment, the pay-on-demand virtual payment card may include a single use account number, a limited use account number, etc.

In one embodiment, the backend for the online marketplace may request, from the financial institution, the pay-on-demand virtual payment card. The request may be made using an application programmable interface.

In one embodiment, the backend for the online marketplace may commit the transaction to a distributed ledger.

In one embodiment, the backend may select the pay-on-demand virtual payment card from one of a plurality of pools of pay-on-demand virtual payment cards based on a payment process. The plurality of pools of pay-on-demand virtual payment cards may be grouped by bank identification number.

In one embodiment, the payment process may be an ACH channel, an electronic payment network, etc.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for using integrated pay-on-demand virtual cards according to one embodiment; and

FIG. 2 depicts method for using integrated pay-on-demand virtual cards according to one embodiment.

### DETAILED DESCRIPTION OF PREFERRED EMBODIMENTS

Embodiments disclosed herein relate to systems and methods for using integrated pay-on-demand virtual payment cards.

Embodiments may include a suite of business-to-business (B2B) payment products that may streamline and add security and controls to the end-to-end online procurement process. Embodiments may integrate with an e-procurement provider or online marketplace, associate a purchase order with an on-demand virtual payment card number, send the pay-on-demand virtual payment card information to the merchant, and deliver reconciliation data to automate reconciliation for both the buyer and the supplier. The payment requests and settlements may occur in real-time, or substantially in real-time, and the process from requisition through reconciliation may be automated.

Although this disclosure may be in the context of B2B payments, it should be recognized that this disclosure is not so limited. Other forms of payments, such as person to business (P2B), business-to-person (B2P), and person-to person (P2P) payments may be implemented as well.

Embodiments may provide some or all of the following: (1) pay-on-demand-based virtual payment card instructions and management APIs; (2) customized interchange rates depending on the commercial relationship with the merchant/marketplace; (3) straight-through processing of the virtual card payment to supplier; and (4) customizable reconciliation files.

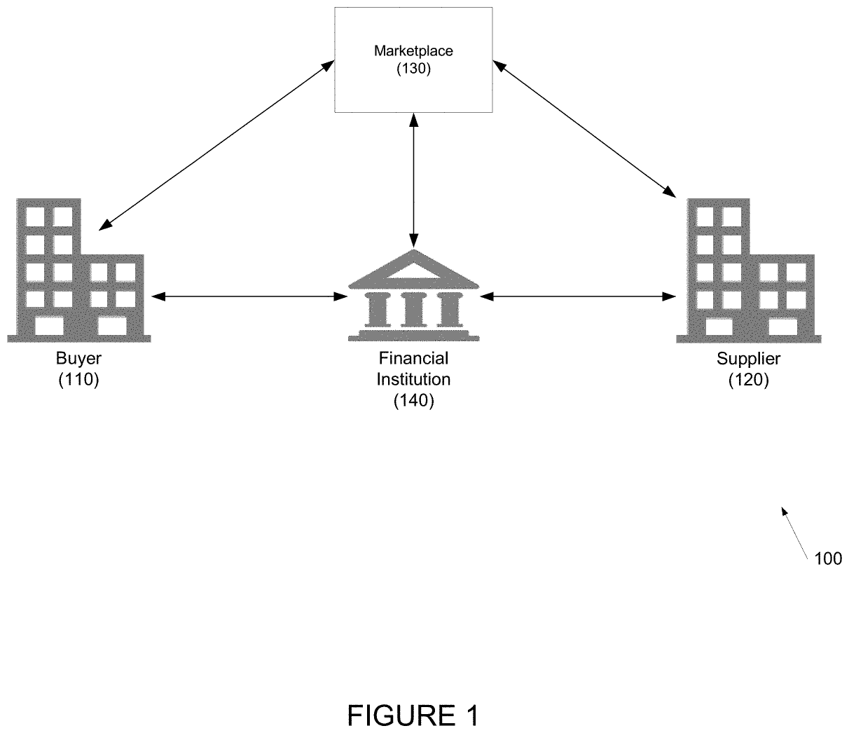

Referring to FIG. 1, a system for using integrated pay-on-demand virtual cards is disclosed according to one embodiment. System 100 may include buyer 110, supplier 120, marketplace 130, and financial institution 140.

In one embodiment, buyer 110 may be any entity that may purchase goods or services using marketplace 130. In one embodiment, buyer 110 may use any suitable electronic device to access marketplace 130, including, for example, smart phones, smart watches, tablet computers, desktop computers, notebook computers, workstations, Internet of Things (IoT) appliances, etc.

Supplier 120 may be a supplier of any suitable good or service that may be purchased through marketplace 130.

Buyer 110 and supplier 120 may be any suitable entities, including individuals, businesses, government agencies, etc.

Marketplace 130 may make items from one or more supplier 120 available to one or more buyer 110. In one embodiment, marketplace 130 may have an online presence, such as a website, that may be made available to buyer 110 and supplier 120.

Financial institution 140 may be a bank, a FinTech service provider, etc. Financial institution 140 may facilitate transactions between buyer 110 and supplier 120 by providing pay-on-demand virtual payment card, such as single use account numbers or limited use account numbers.

In one embodiment, financial institution 140 may manage or maintain a “pool” of pay-on-demand virtual payment cards. In one embodiment, pool of pay-on-demand virtual payment cards. For example, in one embodiment, different bank identification numbers (BINs) may be used to identify different payment processes, payment economics, currencies, buyer and supplier relationships, etc.

In one embodiment, financial institution 140 may host marketplace 130, or may be a partner with a provider of marketplace 130.

In one embodiment, a distributed ledger (e.g., a Blockchain ledger) may be used to record transactions. For example, buyer 110, supplier 120, marketplace 130, and financial institution 140 may each be a node in a distributed ledger network, and may maintain a copy of the distributed ledger or otherwise access a distributed ledger.

In one embodiment, a network of buyers 110 and suppliers 120 may be represented as nodes in a private or public distributed ledger network. The distribute ledger network may use smart contracts to facilitate secure trusted transactions and automate requests, payments, settlements, and reconciliation among the parties. Embodiments may further include a dynamic and trusted method of calculating value shared across parties for any given transaction.

In one embodiment, data from buyers 110 and suppliers 120 maybe aggregated to drive economics and as insights that may benefit each participating entity.

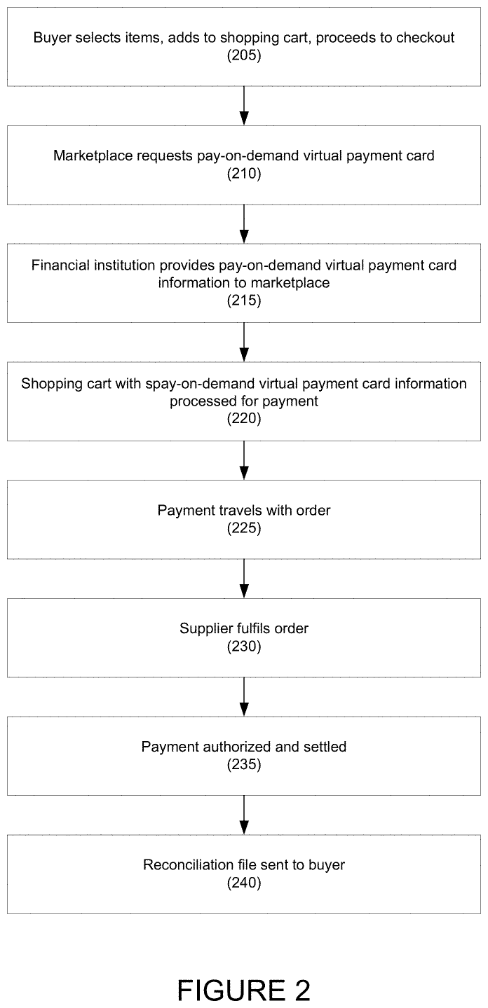

Referring to FIG. 2, a method for using integrated pay-on-demand virtual cards is disclosed according to one embodiment.

In step 205, a buyer, using an electronic device, may select one or more good or services offered by a supplier in an online marketplace. In one embodiment, the buyer may indicate that the buyer will use a pay-on-demand virtual payment card, such as a single or limited use account number, during the checkout process.

In step 210, the marketplace may request a pay-on-demand virtual payment card from the buyer and/or from the financial institution.

In one embodiment, the marketplace may use an API to contact the financial institution to request the pay-on-demand virtual payment card.

In step 215, the financial institution may provide the pay-on-demand virtual payment card information to the marketplace, and, in step 220, the shopping cart may be processed for payment using the pay-on-demand virtual payment card.

In step 225, the pay-on-demand virtual payment card information is provided with the order to the supplier, and, in step 230, the supplier fulfils the order.

In step 235, after receiving the pay-on-demand virtual payment card information, the financial institution may authorize and settle payment from the buyer's account to the supplier's account, and in step 240, the financial institution may send a reconciliation file to the buyer.

Although multiple embodiments have been disclosed, it should be recognized that these embodiments are not exclusive to one another, and aspects and features from one embodiment may be used with others.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for using pay-on-demand virtual payment cards, comprising:
in an information processing apparatus for an online marketplace comprising at least one computer processor;
receiving, from a buyer electronic device, a selection of one or more goods or services offered by a supplier in the online marketplace and an indication that the buyer will use a pay-on-demand virtual payment card to pay for the goods or services;
receiving, from the buyer electronic device or a backend for a financial institution associated with the pay-on-demand virtual payment card, information for the pay-on-demand virtual payment card;
associating the pay-on-demand virtual payment card with the goods or services in a transaction;
providing the transaction to the backend for the financial institution; and
receiving a reconciliation file for the transaction from the backend for the financial institution.

2. The method of claim 1, wherein the pay-on-demand virtual payment card comprises a single use account number.

3. The method of claim 1, wherein the pay-on-demand virtual payment card comprises a limited use account number.

4. The method of claim 1, further comprising:
requesting, from the financial institution, the pay-on-demand virtual payment card;
wherein the request is made using an application programmable interface.

5. The method of claim 1, further comprising:
committing the transaction to a distributed ledger.

6. The method of claim 1, wherein the step of receiving, from the buyer electronic device or a backend for a financial institution associated with the pay-on-demand virtual payment card, information for the pay-on-demand virtual payment card comprises:
selecting the pay-on-demand virtual payment card from one of a plurality of pools of pay-on-demand virtual payment cards based on a payment process.

7. The method of claim 6, wherein the plurality of pools of pay-on-demand virtual payment cards are grouped by bank identification number.

8. The method of claim 6, wherein the payment process comprises an ACH channel.

9. The method of claim 6, wherein the payment process comprises an electronic payment network.

10. A system for using pay-on-demand virtual payment cards, comprising:
an online marketplace comprising a plurality of goods or services, each good or service associated with a supplier;
a financial institution backend in communication with the online marketplace; and
a buyer electronic device in communication with the online marketplace;
wherein:
a backend for the online marketplace receives, from the buyer electronic device, a selection of one of the plurality of goods or services and an indication that the buyer will use a pay-on-demand virtual payment card to pay for the goods or services;
the backend for the online marketplace receives, from the buyer electronic device or a backend for the financial institution associated with the pay-on-demand virtual payment card, information for the pay-on-demand virtual payment card;
the backend for the online marketplace associates the pay-on-demand virtual payment card with the goods or services in a transaction;
the backend for the online marketplace provides the transaction to the backend for the financial institution; and
the backend for the online marketplace receives a reconciliation file for the transaction from the backend for the financial institution.

11. The system of claim 10, wherein the pay-on-demand virtual payment card comprises a single use account number.

12. The system of claim 10, wherein the pay-on-demand virtual payment card comprises a limited use account number.

13. The system of claim 10, wherein the backend for the online marketplace requests, from the financial institution, the pay-on-demand virtual payment card;
wherein the request is made using an application programmable interface.

14. The system of claim 10, wherein the backend for the online marketplace commits the transaction to a distributed ledger.

15. The system of claim 10, wherein the backend for the online marketplace selects the pay-on-demand virtual payment card from one of a plurality of pools of pay-on-demand virtual payment cards based on a payment process.

16. The system of claim 15, wherein the plurality of pools of pay-on-demand virtual payment cards are grouped by bank identification number.

17. The system of claim 15, wherein the payment process comprises an ACH channel.

18. The system of claim 15, wherein the payment process comprises an electronic payment network.
